(19) United States
(12) Patent Application Publication
(10) Pub. No.: US 2003/0236720 A1
(43) Pub. Date: Dec. 25, 2003

(54) Accounts receivable error processing system and method

(76) Inventors: Lale White, Ranco Santa Fe, CA (US); Jeffrey Yates, Vista, CA (US); Dennis Coats, Carlsbad, CA (US)

Correspondence Address: Richman and Associates, PO Box 3333, La Jolla, CA, 92038-3333, US

(21) Appl. No.: 10/283,958

(22) Filed: Oct. 29, 2002

Related U.S. Application Data
(63) Continuation-in-part of application No. 10/001,607, filed on Oct. 30, 2001.
(60) Provisional application No. 60/340,186, filed on Oct. 30, 2001.

(51) Int. Cl. G06F 17/60

(52) U.S. Cl. 705/30

(57) ABSTRACT

A system and method for detecting and processing an error in a service order in an accounts receivable system where the system includes a database that includes a plurality of error processing selection based on the error type. The database may also vary as a function of the payor for the service order. The system processes the error based on the determined error processing selection.

### CROSS REFERENCE TO RELATED APPLICATIONS

This invention is a continuation-in-part of patent application Ser. No. 10/001,607 filed Oct. 30, 2001, Attorney Docket Number XI001US, and entitled “Accounts Receivable Error Processing System and Method” and related to Provisional Patent Application No. 60/340,186, filed Oct. 30, 2001, Attorney Docket Number XI005US, and entitled “Medical Accounts Receivable System and Methods” which are hereby incorporated by reference for their teachings.

### BACKGROUND OF THE INVENTION

1. Field of the Invention

This invention relates to accounts receivable error processing systems and methods, and more particularly to service request order entry accounts receivable error processing systems and methods.

2. Description of Related Art

Service Provider Accounts Receivable (“AR”) systems are designed to bill clients for services as they are performed. In some applications, the financially responsible party is a client of the requesting client. Further, the client of the requesting client may have a form of insurance whereby an insurance provider may be responsible for all or some of the billable services. In addition, the amount that may be billed for the provided service may vary as a function of the insurance provider. For example, a Doctor (requesting client) may request a Laboratory (client service provider) to perform several tests for a Patient (requesting client's client) where the Patient has an Insurance provider that pays a fixed price for tests or a group of tests.

Insurance providers commonly will not pay a claim for services performed for an insured unless the claim meets many criteria. Failure to meet these criteria leads to non-payment of services in many cases. Accordingly, a need exists for an AR system and method that can reduce the errors that may lead to non-payment of services performed for an insured party by their Insurance provider.

### SUMMARY OF THE INVENTION

The present invention includes an accession processing system and method of reducing errors in a plurality of accession records stored in a database of the accession processing system. Each accession record includes a plurality of fields. Then invention enables a user to select a condition defining an error. Then invention then retrieves one of the plurality of accession records and determines whether the selected condition defining an error is satisfied by the one of the plurality of accession records. The one of the plurality of accession records that satisfied the selected condition defining an error are displayed.

Each accession record may represents a service request. Further each accession record may include a field indicating the payor. In invention may also enable a user to select a range of dates and further determine whether the selected condition defining an error is satisfied by the one of the plurality of accession records and whether the accession record falls within the selected range of dates. The range of dates may correspond to the service date for each accession record of the plurality of accession records.

The invention may also enable a user to select a sort field of a plurality of fields. Further, the invention may sort the ones of the plurality of accession records that satisfied the selected condition defining an error. In one embodiment, the invention may enable a user to select one of the plurality of accession records that satisfied the selected condition defining an error and enable a user to select an error handling action to the selected one of the plurality of accession records that satisfied the selected condition defining an error. The invention may then perform the selected error handling action to the selected one of the plurality of accession records that satisfied the selected condition defining an error. Further, the error handling action may include one of automatic matching, manual match, manual, correspondence, outside referral, and hold.

### BRIEF DESCRIPTION OF THE DRAWINGS

FIG. 1 is a block diagram of exemplary client service provider related AR architecture in accordance with the present invention.

FIG. 2 is a block diagram of an exemplary central AR data processing system shown in FIG. 1.

FIG. 3 is a flowchart of a laboratory service request process in accordance with the present invention.

FIG. 4 is an illustration of an exemplary Physician Laboratory Service Request Order Entry screen in accordance with the present invention.

FIGS. 5A-5G are illustrations of exemplary Error Summary Review screen showing exemplary errors groups and associated error types/reasons in accordance with the present invention.

FIG. 6 is a flowchart of an overall error summary checking process in accordance with the present invention.

FIG. 7 is an illustration of an exemplary Error Type/Reason Handling database maintenance screen in accordance with the present invention.

FIG. 8 is a flowchart of an exemplary error type/reason handling database maintenance process in accordance with the present invention.

FIG. 9 is a flowchart of an exemplary accession error processing method in accordance with the present invention.

FIG. 10 is a flowchart of an exemplary user directed error processing method in accordance with the present invention.

FIG. 11 is a flowchart of an exemplary error processing method for an AR data processing system to be performed in conjunction with the flowchart of FIG. 10 in accordance with the present invention.

FIG. 12 is a flowchart of an exemplary accession error searching method in accordance with the present invention.

FIG. 13 is a flowchart of an exemplary error handling method in accordance with the present invention.

FIG. 14 is an illustration of an exemplary accession error search screen in accordance with the present invention.

FIG. 15 is an illustration of the exemplary accession error search screen of FIG. 14 showing exemplary search filters/fields in accordance with the present invention.

FIG. 16 is an illustration of the exemplary accession error search screen of FIG. 14 showing exemplary sort fields in accordance with the present invention.

FIG. 17 is an illustration of the exemplary search results screen in accordance with the present invention.

FIG. 18 is an illustration of the exemplary search results screen of FIG. 17 showing exemplary action selection in accordance with the present invention.

FIG. 19 is an illustration of the exemplary search results screen of FIG. 17 showing exemplary outside agency selection in accordance with the present invention.

Like reference numbers and designations in the various drawings indicate like elements.

### DETAILED DESCRIPTION OF THE PREFERRED EMBODIMENTS

Throughout this description, the preferred embodiment and examples shown should be considered as exemplars, rather than as limitations on the present invention.

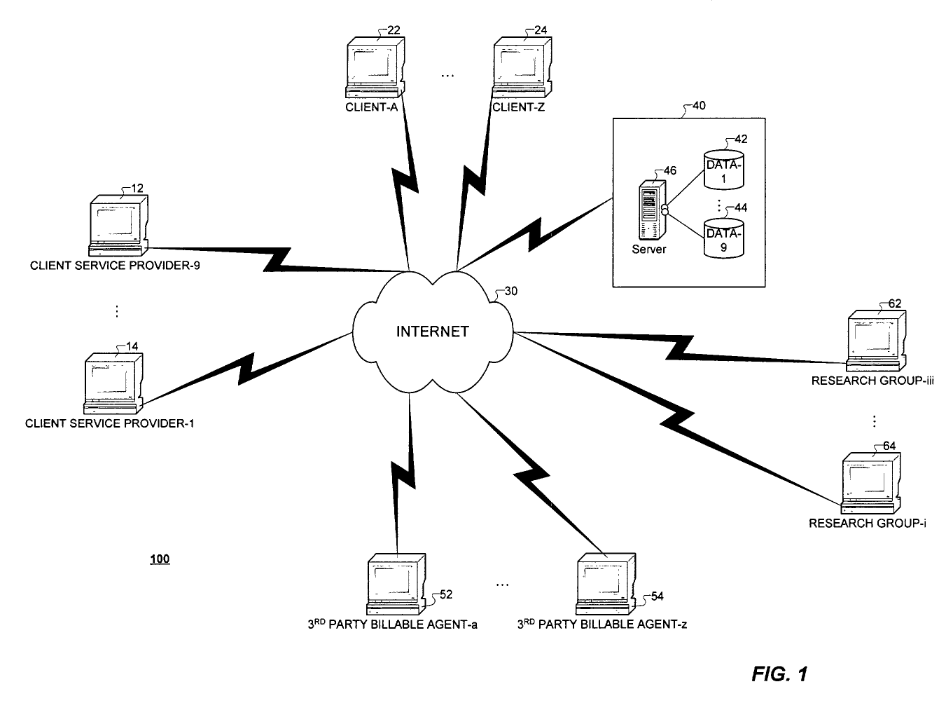

FIG. 1 is a block diagram of an exemplary client service provider AR architecture 100 in which the present invention may be employed. The architecture 100 includes a plurality of client service request/order entry systems (“COE”) 22, 24, a plurality of client service request/order entry processing systems (“SOEP”) 12, 14, a plurality of third party billable agent systems (“BAS”) 52, 54, and a plurality of research group systems (“RGS”) 62, 64 coupled to a central AR data processing system (“CARS”) 40 via an network of networks or Internet 30. In one exemplary embodiment a user of a COE 22, 24 generates a service request using an order entry program maintained on the CARS 40. When an order entry is submitted at a COE 22, 24, the data is maintained in one or more databases located on a data storage device 42, 44 in the CARS 40. A SOEP 12, 14 may also perform order entry and receive service requests from COE 22, 24 via the CARS 40. A SOEP 12, 14 may indicate when a service request is completed via the CARS 40. The CARS 40 may then generate and transmit a request for payment for the rendered service to an appropriate BAS 52, 54. The CARS 40 may direct a RGS 62, 64 to search for information related to a processed service request.

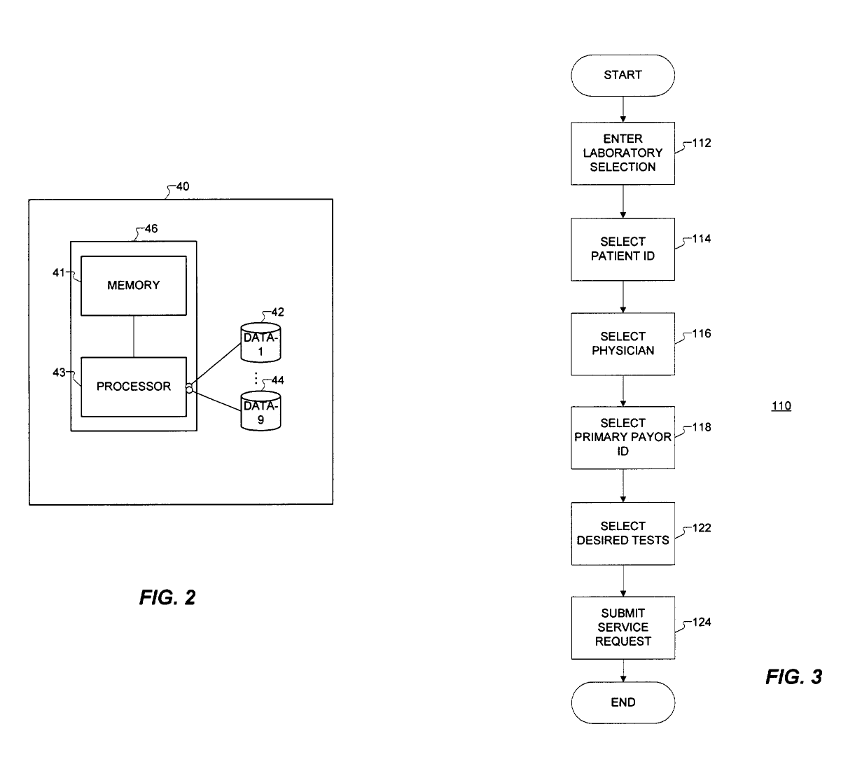

FIG. 2 is a block diagram of an exemplary CARS 40. The CARS 40 includes a server 46 and plurality of data storage devices 42, 44 such as optical, magnetic, or other permanent data storage devices. The CARS 40 stores databases on the storage devices 42, 44 where the databases are used to maintain and process service requests. The CARS 40 may also store program files on the storage devices 42, 44 where the program files include executable instructions for processing service requests and enabling the COE 22, 24 and SOEP 12, 14 to process service requests. The CARS 40 server 46 includes a memory 41 coupled to a processor 43 where the processor is also coupled to the storage devices 42, 44. The processor 43 executes program instructions for processing service requests and supporting COE 22, 24 and SOEP 12, 14. The memory 41 stores data and program instructions where the data may include service requests and information related to the requests that may be stored in a database on a storage device 42, 44.

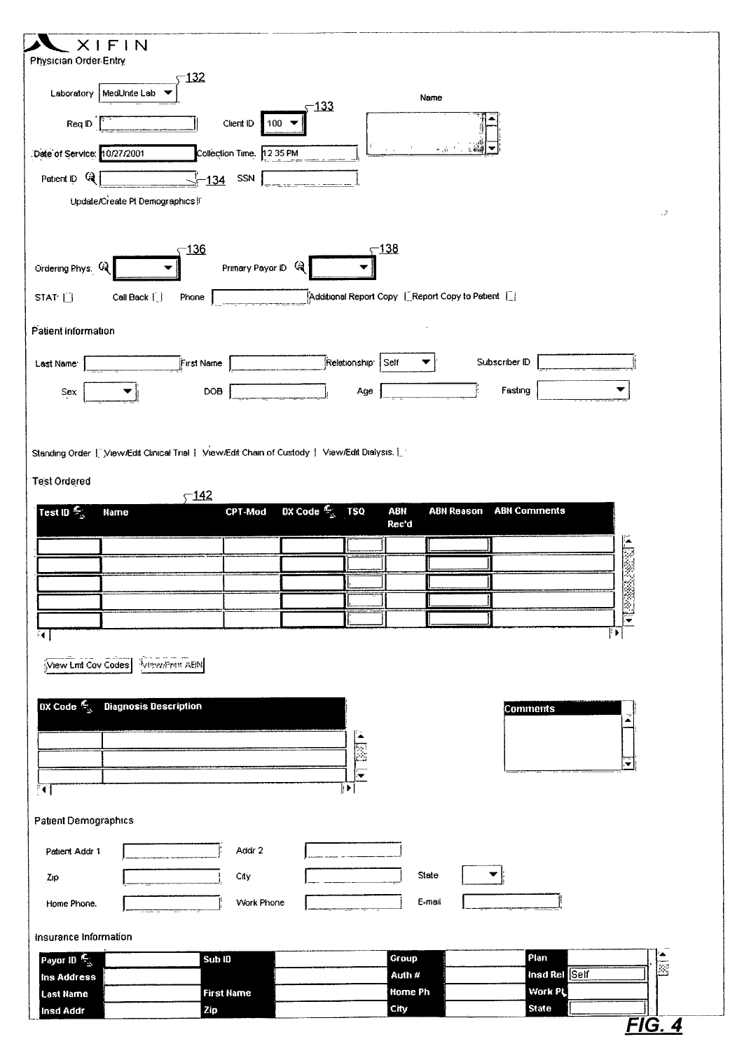

The exemplary embodiment 100 is explained in detail with reference to an application of the system 100 to a particular client service and client paradigm. In this example, the client service providers 12, 14 are a plurality of medical laboratories, the clients are physicians that order laboratory tests for patients, and the billable agents are patient's medical insurance providers. Accordingly in this example, a physician via one of the plurality of COE 22, 24 may order one or more laboratory tests from a laboratory. An exemplary Physician laboratory test ordering system/method is presented with reference to FIGS. 3 and 4.

FIG. 3 is a flowchart of an expedited laboratory service request process in accordance with the present invention and FIG. 4 is an illustration of an exemplary Physician Laboratory Service Request Order Entry (“PLSROE”) screen 130. It is noted that the sequence of the process of FIG. 3 is not fixed. In the service request entry process 110, a user of a COE 22, 24 first selects the desired service provider, in this example a laboratory. FIG. 4 shows the selection of a laboratory at box 132. The PLSROE screen may be provided to a COE 22, 24 from the CARS 40 via the Internet 30. The PLSROE screen indicates that the client ID 133 associated with the order is also selectable. The client ID 133 may also be determined by the Internet Protocol address of the COE 22, 24 requesting access to the CARS order entry system 40. The COE user may then select a patient ID at step 114 (box 134 of the PLSROE) representing the patient for whom the tests will be performed. When the patient has been entered in the CARS 40 system previously for the client, the patient may have an associated ID linked to saved patient information in a database record. Otherwise, the COE User may enter the patient information.

Then a COE user may select the patient's Physician at step 116 (box 136 of FIG. 4). The CARS 40 may correlate the patient to a Physician based on past orders. Additionally, the user may enter the patient's primary payor ID at step 118 (box 138 of FIG. 4). The primary payor may be a medical insurance provider such as Medicare, Blue Cross, Blue Shield, private Insurance provider, Health Maintenance Organization (“HMO”), or other such provider. In this example, each BAS 52, 54 may be an insurance provider organization or a group that processes claims for a related organization. When a new Insurance provider is presented, a user may create or request a CARS 40 administrator to generate a new Payor ID for the provider with related contact, pricing codes, consolidation codes, and billing requirements.

The user then selects the test(s) the Physician has ordered for the patient by entering one or more Test IDs at step 122 (box 142 in FIG. 4). The test IDs may be specific for the selected Laboratory (service provider). As shown in FIG. 4, the COE user may also enter other information as required by the Payor or Laboratory. For example, in order to receive payment for certain tests, a Payor may require a related diagnosis description. Then the COE user submits the service request order at step 124. At this point, the CARS 40 may generate a database record detailing the service request order, termed an accession in one embodiment. A SOEP 12, 14, may similarly generate an accession by following a similar process as shown in FIG. 3.

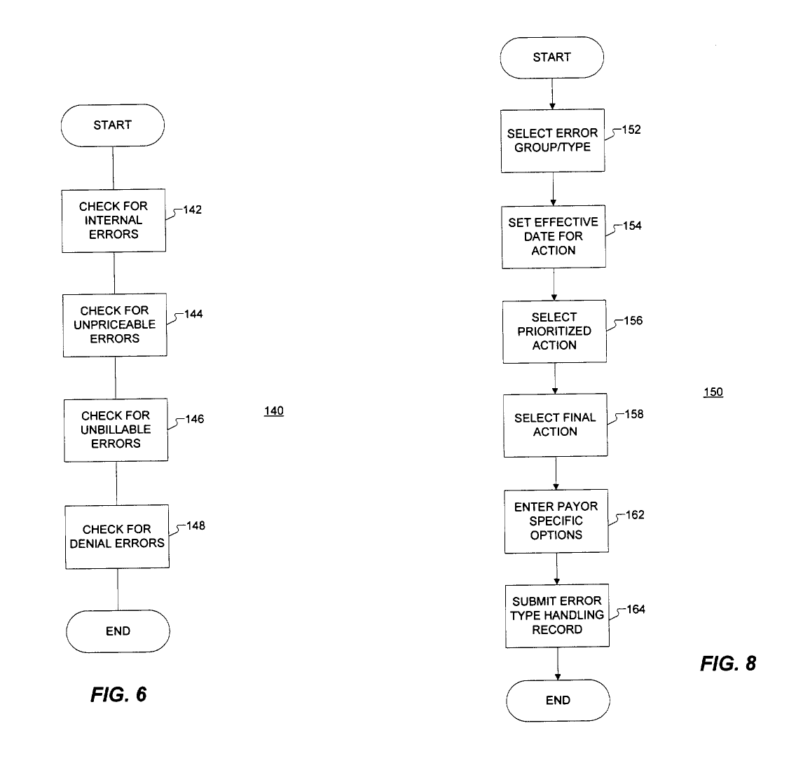

Once the order or accession is submitted, the CARS 40 tracks, updates, and adds relational records stored in additional databases as the order is processed through the laboratory (service provider), results reporting, pricing, billing and payments collection. As noted, insurance providers (3^{rd} party billable agent) reject a significant percentage of submitted insurance claims, in part, due to missing or invalid information. The present invention, CARS 40 reduces the percentage of rejected claims by performing a series of error checks on accession records prior to submission to a BAS. In one embodiment, the CARS 40 checks accession records for different categories of errors as shown in FIG. 6. As shown in FIG. 6, the CARS 40 checks accession records for internal, unpriceable, unbillable, and denial errors. Internal errors are not correlated to a payor, unpriceable and unbillable errors may be specific to a payor, and denial errors relate to accession records that have been submitted and rejected by a payor.

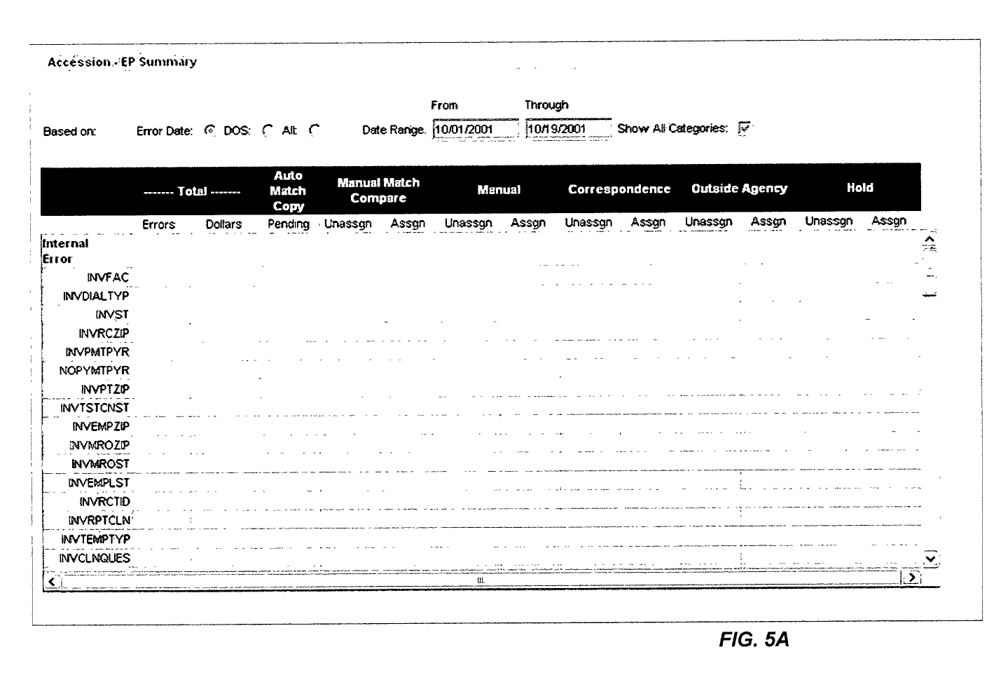

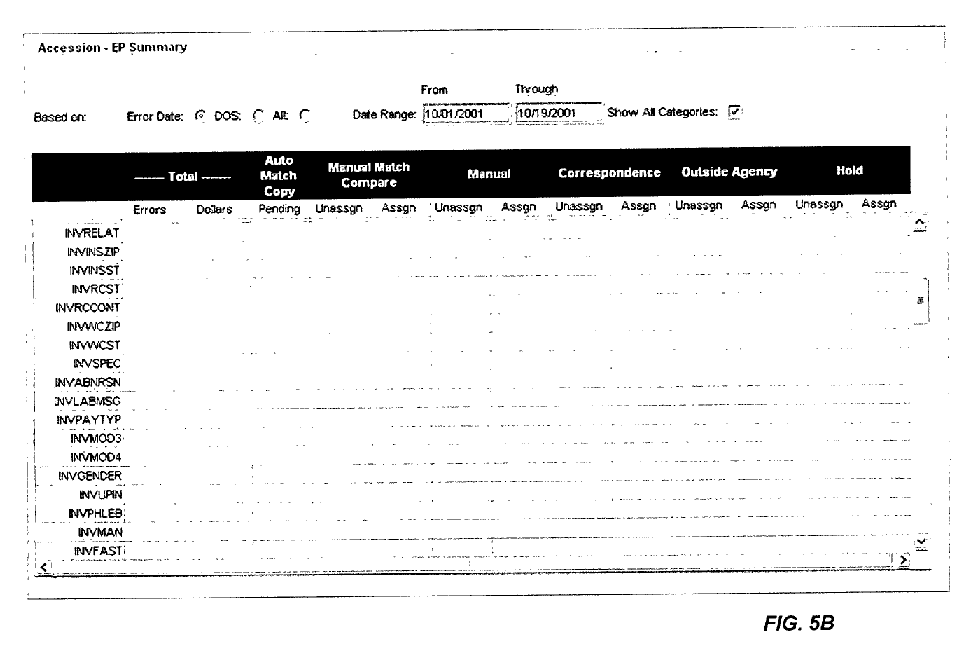

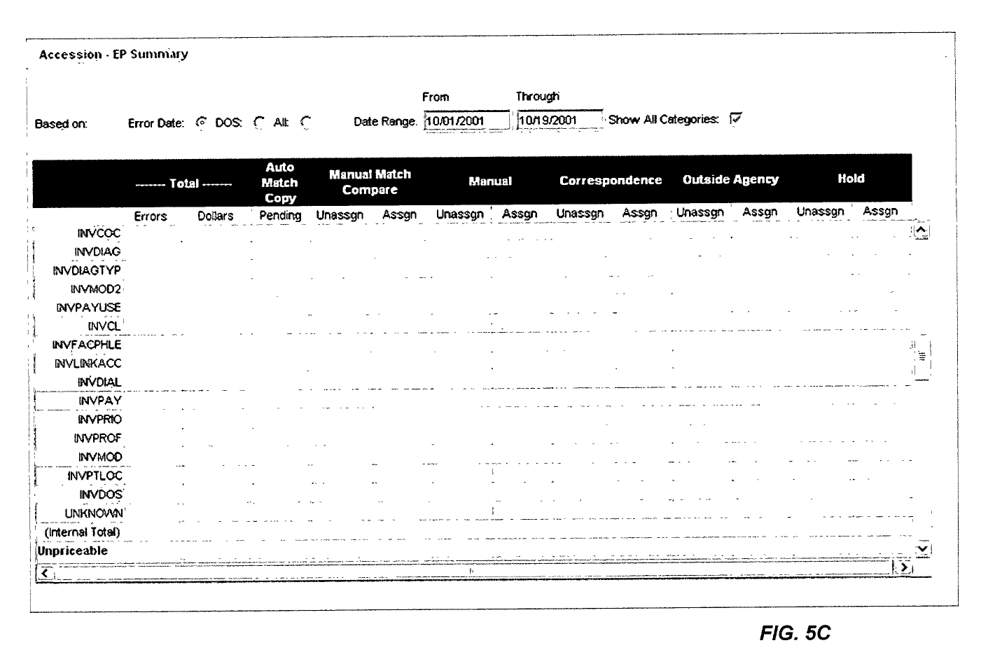

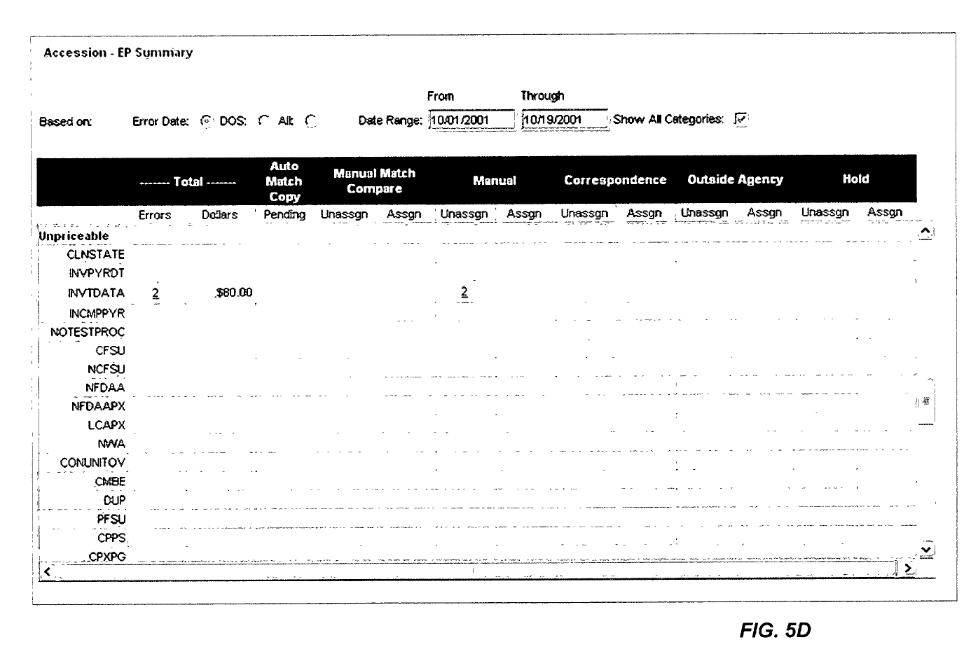

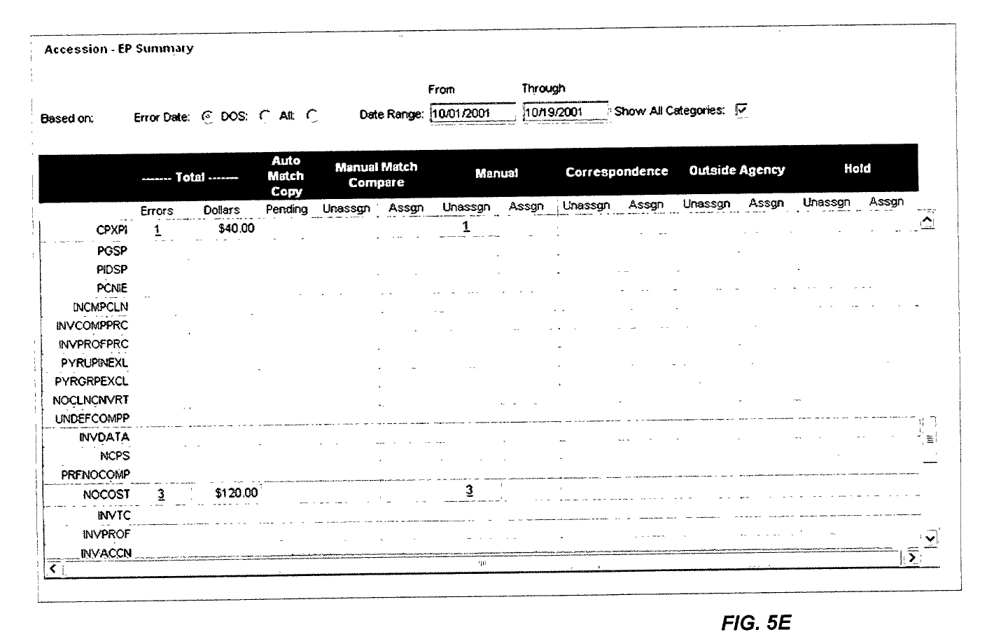

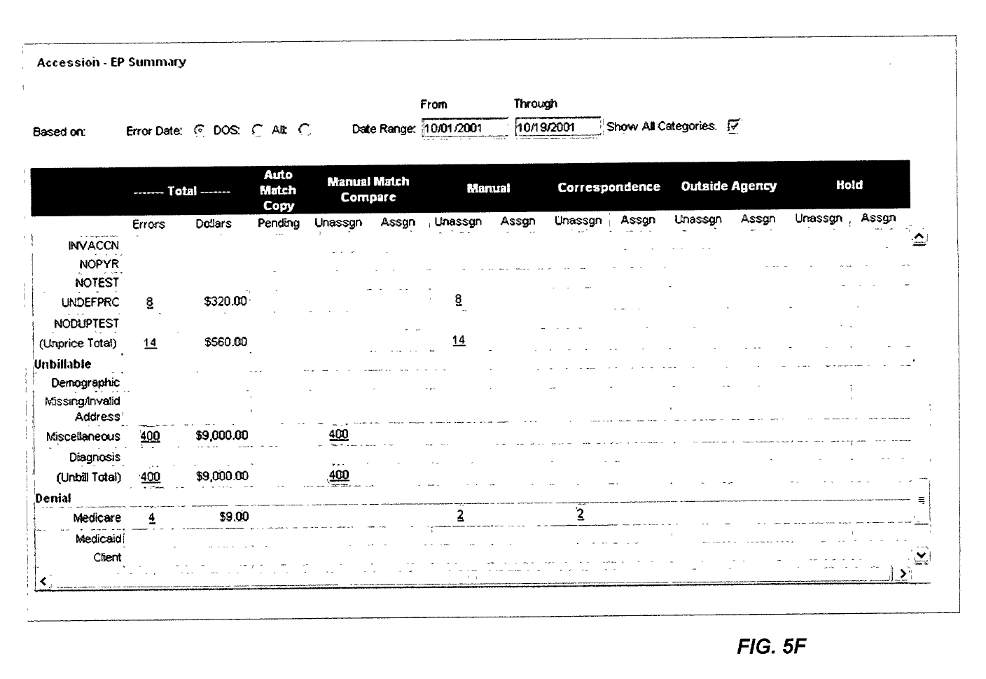

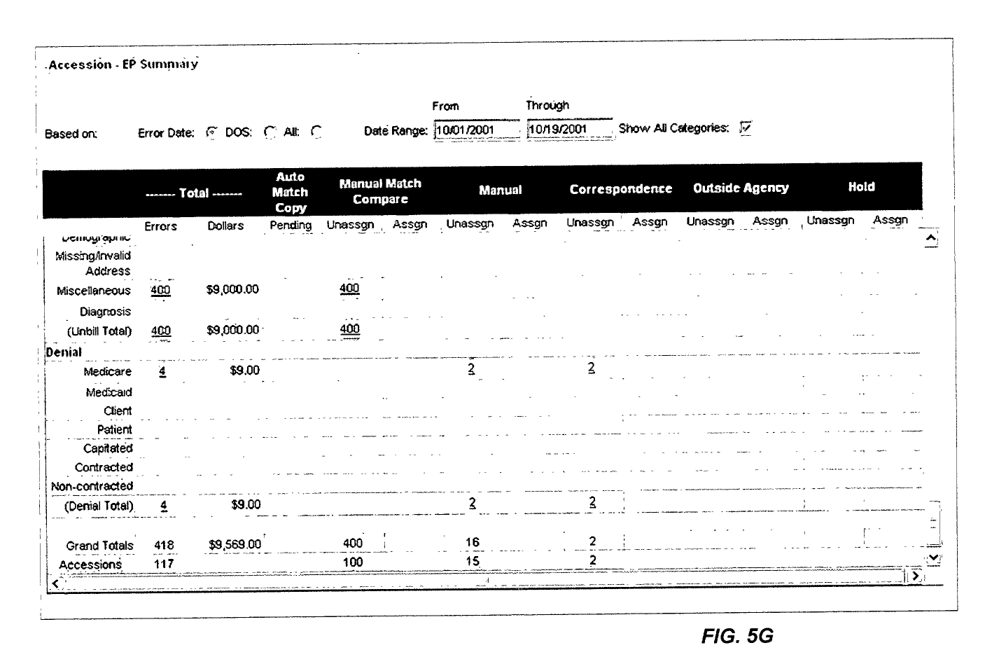

FIGS. 5A to 5G depict a list of exemplary error types for Internal Errors, Unpriceable Errors, Unbillable Errors, and Denial Errors. Table One provides a description for each of the error types. The internal error types are based on missing or invalid order entry data in an accession. In a preferred embodiment, the order entry data is corrected for completeness as entered and submitted. A user, however, based on location, i.e., 12, 14 or 22, 24 may override an error message for missing or invalid data and thus create an accession with one or more missing or invalid fields in error. The internal errors types are stored in an error type database. In an exemplary embodiment, one or more records of the error type database may correspond to an error type shown in Table One where the record(s) define the error testing criteria for one or more fields of an accession, e.g., a field having a null value, value greater than, less than a fixed amount, not matching a pattern, or not present in a lookup table. Accordingly, a CARS 40 user or administrator may add, modify, or delete accession database record error checks that correspond to an error type by maintaining an error check database.

FIG. 6 is a block diagram of an exemplary error searching process 140. As shown, the process checks for internal errors (step 142). The CARS 40 may check for internal errors by evaluating the field(s) and error criteria defined by the error type database for each internal error type. The process 140 also checks for unpriceable and unbillable errors (steps 144 and 146). The CARS 40 may check for unpriceable and unbillable errors by evaluating the field(s) and error criteria defined by the error type database for each unpriceable and unbillable error type. The process 140 also checks for denial errors (step 148). The CARS 40 may check for denial errors by reviewing a denied accession database where an accession is added to the database when a BAS sends a corresponding claim denial.

Due to the centralization of the CARS 40, the present invention provides several actions that may be performed to process/resolve each error condition (defined by an error type.) As shown in FIGS. 5A to 5G, the actions may include an automated matching, manual match, correspondence generation action, delegation to an outside agency, and hold. In one exemplary auto match process when some errors such as missing or invalid group ID or similar errors, the CARS 40 may search through other accession records for the missing or invalid data based on a common key or combination of keys such as the patient's social security number. When a complete match is detected, the CARS 40 will replace the accession field in error with the matching accession field not in detectable error. The CARS 40 denotes that matches have been found and enables the replacements to performed for one or more accessions based on varying criteria, such as date range, client ID, payor ID, and Laboratory. When a match is not exact but close as defined by a criteria (a certain percentage of characters of a key field match), the CARS 40 may indicate the accession field error requires a manual match comparison.

In a preferred embodiment, the responsibility for reviewing a match comparison may automatically be assigned to a particular CARS 40 administrator based on other accession fields, such as the Payor, Client, and Laboratory. In another embodiment, detected errors requiring manual match may be initially unassigned. A CARS 40 administrator may then assign one more more accession records having detected manual match compare errors to one or more processors by reviewing each accession record or by applying criteria to break one or more accessions into groups. Once a manual match error is assigned, the CARS 40 may invoke a cycle based reminder system to encourage the assigned processor to review such errors where the cycles may be determined by the assigning user or be determined by the corresponding error type.

When the CARS 40 does not find a partial match for an error condition (having an error field), the system 40 may group the error type with other unmatchable error types. Similar to above, in a preferred embodiment, the responsibility for manually reviewing these detected errors may automatically be assigned to a particular CARS 40 administrator based on accession fields, such as the Payor, Client, and Laboratory or the errors may be initially unassigned. A CARS 40 administrator may then assign one or more accession records having detected manual errors to one or more processors by reviewing each accession record or by applying criteria to break one or more accessions into groups. Once a manual error is assigned, the CARS 40 may also invoke a cycle based reminder system to encourage the assigned processor to review such errors. Depending on the manual error type, a CARS 40 processor may not be able to correct the one or more accessions fields that generated the error type.

The processor may then direct the CARS 40 to generate correspondence to the appropriate party, i.e., Client, Physician, Patient, or Laboratory requesting the data needed to correct the accession field(s). The CARS 40 may also invoke a cycle based reminder system based on the initial correspondence date that generates reminder letters to the party or others to encourage the party to provide the missing or invalid data. Further, the CARS 40 may assign the debt to another party upon completion of a cycle where the parties failure to provide the information prevents the CARS 40 from generating an acceptable claim for a Payor. In some circumstances, a CARS 40 processor or the CARS 40 may automatically direct certain error types to outside agencies for correction.

As shown in FIG. 1, the CARS 40 may be coupled to one or more RGS 62, 64 where the RGS 62, 64 may perform research or have access to other databases to correct an accession field(s) generating the assigned error type. In an exemplary embodiment, the process is completely automated where the CARS 40 sends one or more accession errors to a RGS 62, 64 electronically and the RGS 62, 64 sends the corrected data for submission in the accession record electronically to the CARS 40. Accession error types directed to RGS may also initially be unassigned and a CARS 40 administrator may assign one or more accession errors to a RGS based on other accession field data similar to manual and manual match compare error types. Finally, certain error types may by default be placed in on unassigned or assigned Hold.

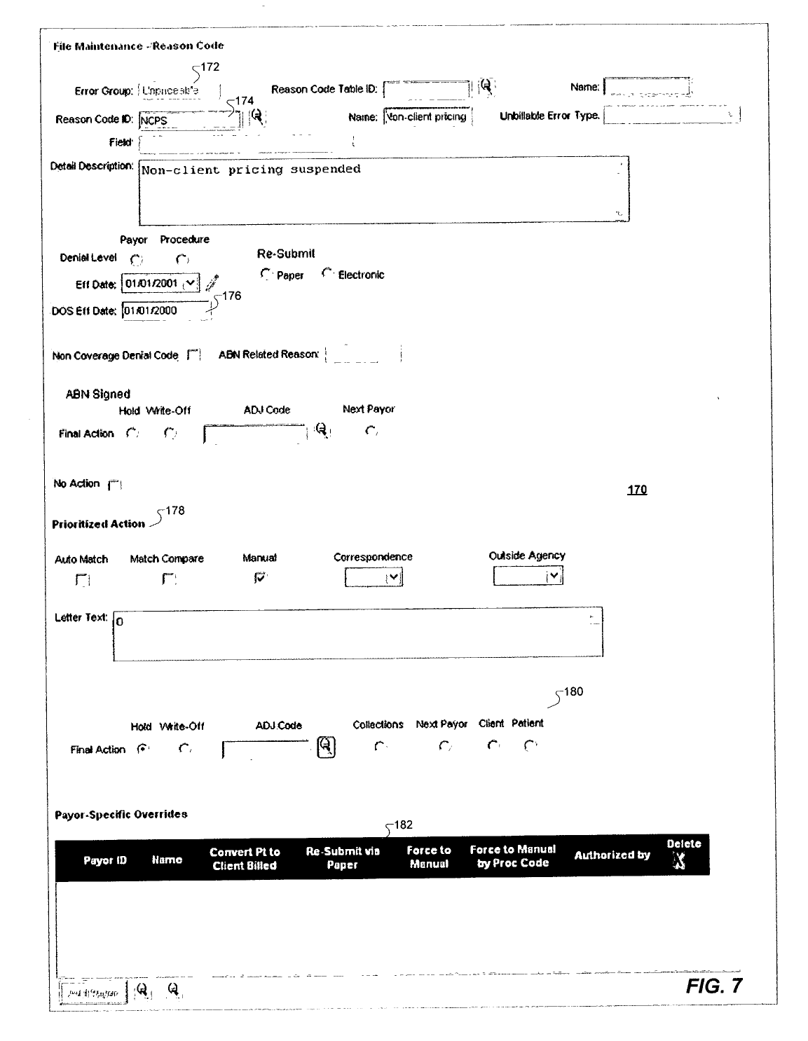

A CARS 40 administrator may review unassigned held accession errors to determine the appropriate course of action such as correspondence, submission to an outside agency, or assignment to hold for a period of time. In a preferred embodiment for each error type there may be a preferred handling protocol. In such an embodiment, an error type handling database may be maintained where one or more records corresponds to each error type and defines one or more actions to be taken when an error corresponding to the error type occurs. For example, FIG. 7 is an illustration of exemplary Error Type/Reason Handling database maintenance screen 170 in accordance with the present invention and FIG. 8 is a flowchart of the exemplary error type/reason handling database maintenance process 150 in accordance with the present invention.

In this embodiment, the CARS 40 user first selects an error type/reason (step 152) by selecting the error group (internal, unpriceable, unbillable, denial) and the specific error type (boxes 172, 174 of FIG. 7). Then the user may select the date when the error type handling record becomes active/effective (step 154, box 176 of FIG. 7). The database may have multiple records for the group/error type where the effective date varies. During error processing of accessions, the accession date of service may be compared to the effective date of the handling record to determine whether to apply the record when the accession meets the criteria for the associated error. Then the CARS 40 will determine the next action based on prior error code configuration where the actions include auto match, match compare, manual, correspondence, outside agency as described above (step 156, section 178 of FIG. 7).

The CARS 40 selects a final action for an error group/error type (step 158) based on prior error code configuration. As shown in FIG. 7 (section 180), possible selectable final actions may include Hold, Write-Off, Collections, Next Payor, Client, Patient where collections indicates forwarding the bill to a collections agency for processing, Next Payor indicates forwarding a bill for the accession to the next Payor indicated on the accession. A bill may also be sent directly to the client (via the internet to a COE or my mail) or to the Patient. Accordingly when other actions fail, the CARS 40 may invoke the selected final action for the error as determined in the corresponding error handling database record.

A CARS 40 user may also enter specialized actions to be performed for specific Payors (step 164, section 182 of FIG. 7) for an error. Certain Payors may limit the actions that may be performed to collect a bill for their patient. In this embodiment, a CARS 40 user may limit or restrict the handling of an error type for one or more Payors (a different relational record may be created for each said Payor and linked to the primary error handling database record for the error. In the exemplary embodiment shown in FIG. 7, the payor-specific actions a CARS 40 user may select include converting patient to client billed, resubmitting a hardcopy of the bill, forcing the error to be manually processed, and forcing the error to be manually processed based on the error code or error code/test procedure code combination.

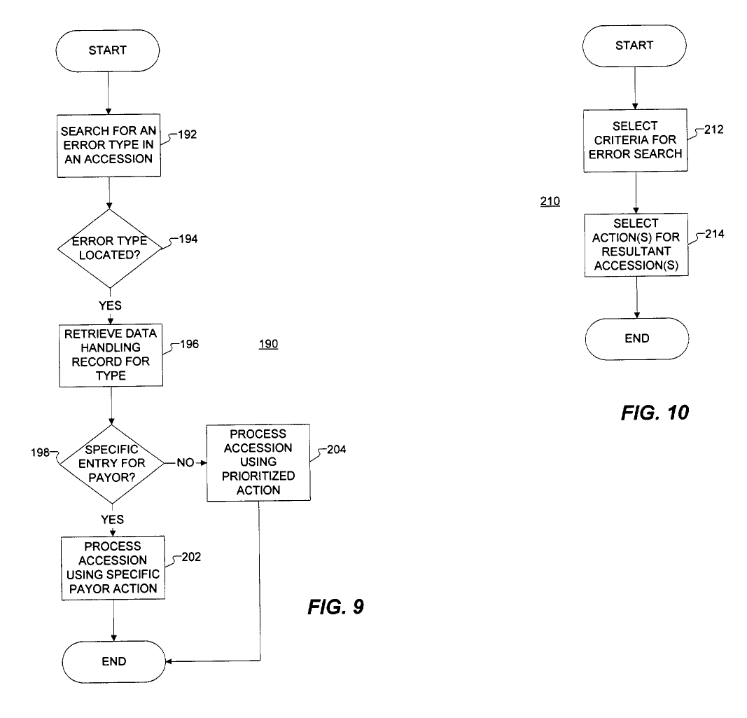

FIG. 9 is a flowchart of one exemplary method 190 that may be employed to process errors detected in an accession. The method 190 first searches for an error type in an accession (step 192). One or more fields of the accession may be evaluated to determine whether the error condition specified by the error type exists. When an error type is located (step 194), one or more records in the error handling database that correspond to the error type are retrieved (step 196). The error handling database records are evaluated to determine if there is a specific action designated for the payor associated with the accession (step 198). When a payor specific action is located, the accession error is processed using the specific action (step 202). Otherwise, the accession error is processed using the prioritized action (step 204).

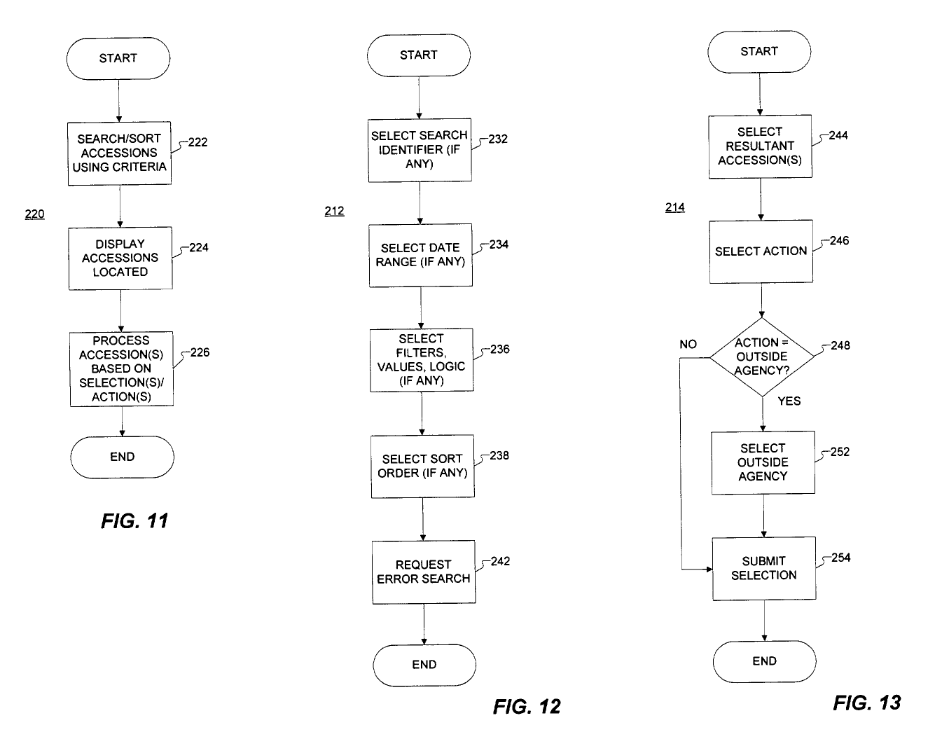

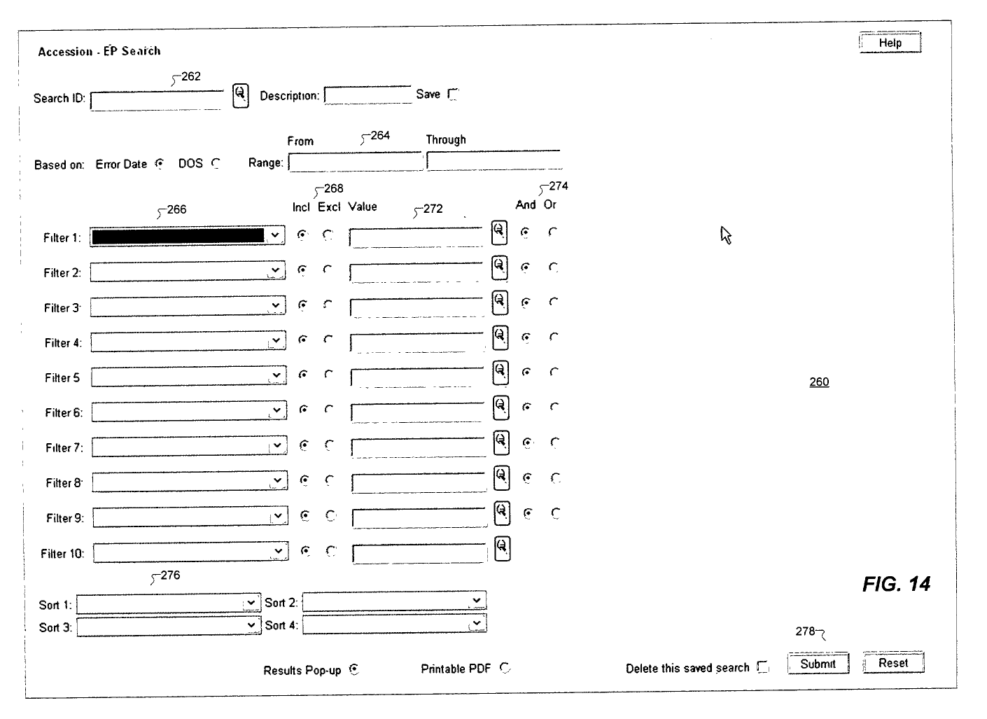

FIG. 10 is a flowchart of an exemplary error processing method 210 in accordance with the present invention. FIG. 11 is a flowchart of an exemplary error processing method for an AR data processing system to be performed by the CARS 40 in conjunction with method 210 in accordance with the present invention. In these preferred processes 210, 220, a user via COE 22, 24 or SOEP 12, 14 or administrator coupled to CARS 40 may select error criteria for accessions and select actions to process accessions with errors (as defined by the selected criteria). In method 210, a user or administrator first selects criteria defining errors in accessions (step 212). FIG. 12 is a flowchart of an exemplary accession error defining method 212 in accordance with the present invention and FIG. 14 is an illustration of an exemplary accession error search screen 260 in accordance with the present invention.

In the exemplary method 212 shown in FIG. 12, a user may select a search identifier (step 232). In exemplary screen 260, a user may create a new search identifier or search for previously saved search identifiers. The search identifier may also have a description. In process 212, a user may then select a date range for the accessions to be searched for errors (step 234). The date may be the date the error occurred or the date of service (“DOS”) (section 264 of screen 260 of FIG. 14). The user may select the filters, values and logic that define error criteria/condition in an accession (step 236). As shown on screen 260 in FIG. 14, a user may enter the filter or field 266 and whether meeting the filter includes or excludes the accession 268 (as having an error). The user may then enter one or more values that the filter may match (272). When multiple values are entered, the values are Boolean “ored”. The user may also select whether the condition defined by the filter, include/exclude and values (266, 268, 272) is to be Boolean “And” or “Or” (274) with other conditions.

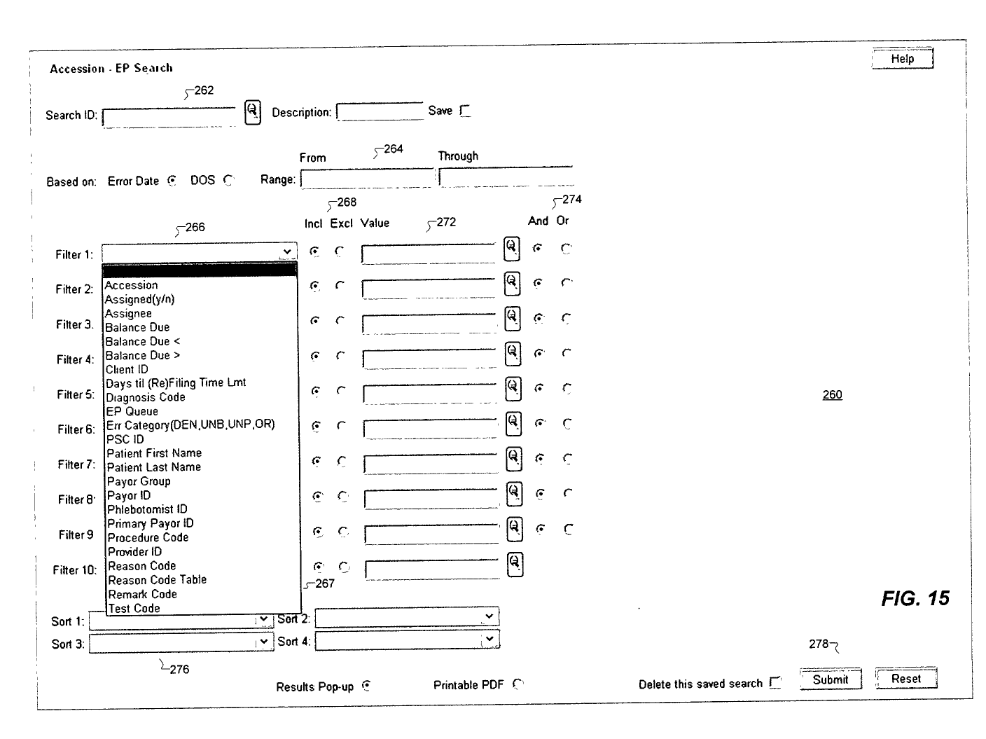

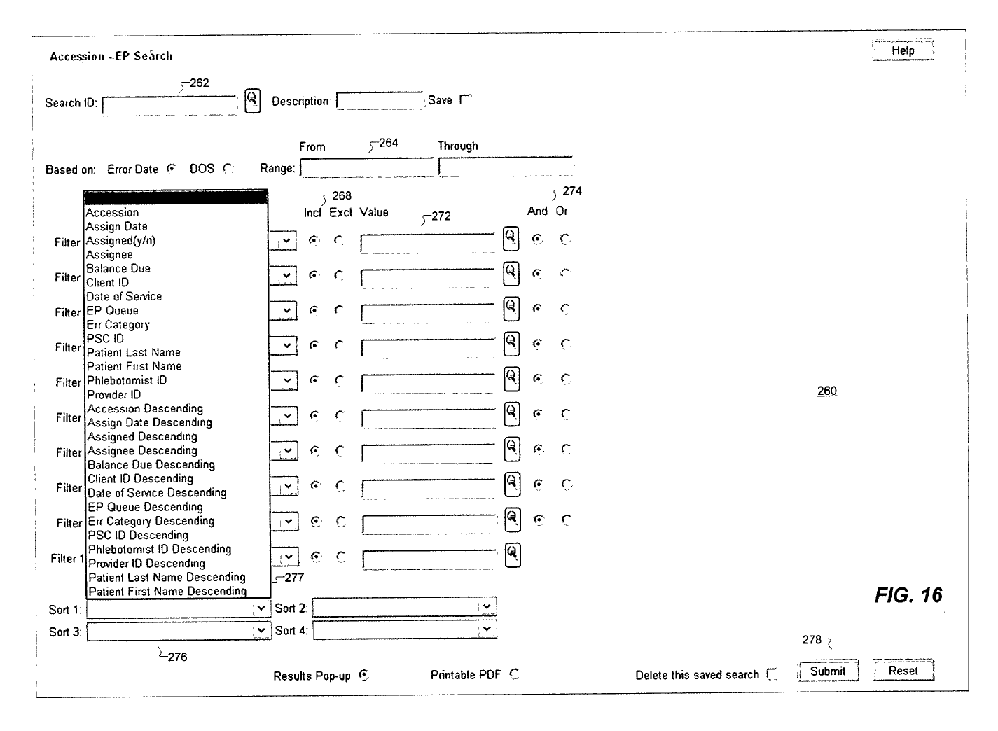

FIG. 15 is an illustration of the exemplary accession error search screen of FIG. 14 showing exemplary search filters/fields 267 in accordance with the present invention. The user may select a field/filter 267 to be compared to one or more values (272). A user may also select one or more sort fields for the resultant accessions to be ordered thereby. FIG. 16 is an illustration of the exemplary accession error search screen of FIG. 14 showing exemplary sort fields 277 in accordance with the present invention. In one exemplary embodiment, a user may select up to four sort fields (276). Then the user may submit the search (step 242) (278 of screen 260). Upon submission the selections, the CARS 40 searches for accessions that meet the selected date range and filter (error definition) conditions and then sorts the resultant error accessions based on the selected sort fields (if any) (step 222 of FIG. 11). The CARS 40 then displays the accessions defined by the user selections (step 224).

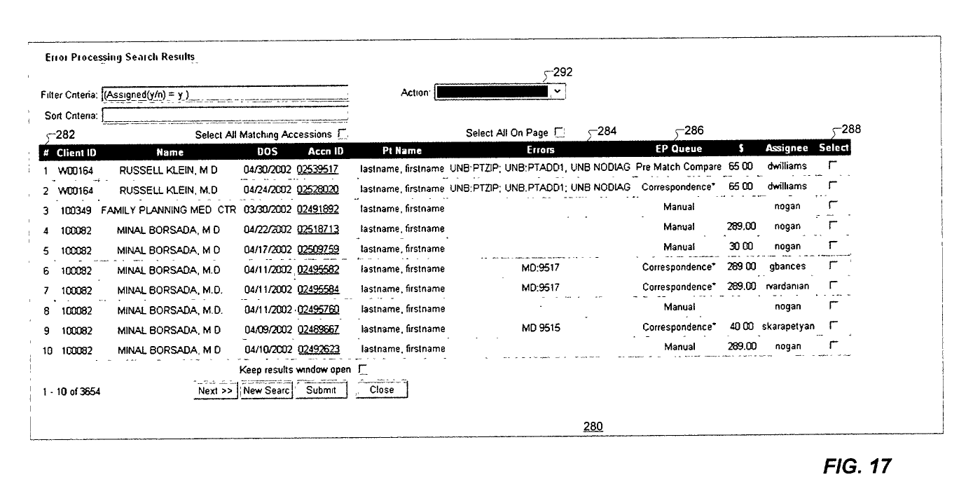

FIG. 17 is an illustration of the exemplary search results screen 280 in accordance with the present invention that the CARS 40 may produce to show the resultant accessions 282. As shown in FIG. 17, the results screen includes accession numbers 282, errors 284, error queue 286 and selection blocks 288. In one exemplary embodiment, the errors (284) are error conditions defined by the automated error search and error condition database. The error queue 286 is the current error handling action designated for the accession. FIG. 13 is a flowchart of an exemplary error handling method 214 in accordance with the present invention that a user may employ to modify the error handling of one or more accessions in the results. In process 214 a user may select one or more accessions whose error handling is to be assigned/modified. In an exemplary embodiment a user may select all matching accessions, select all accessions on a page, or selection particular accessions (screen 280).

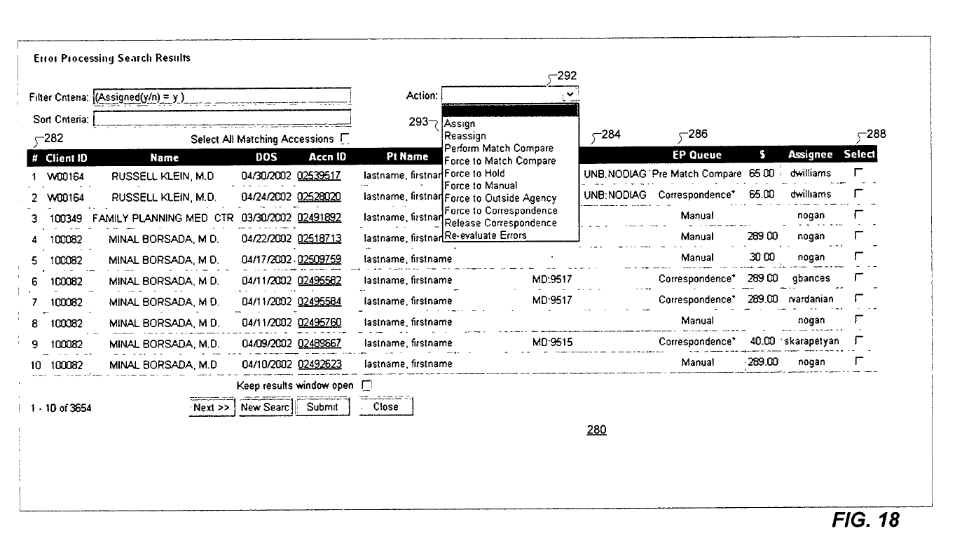

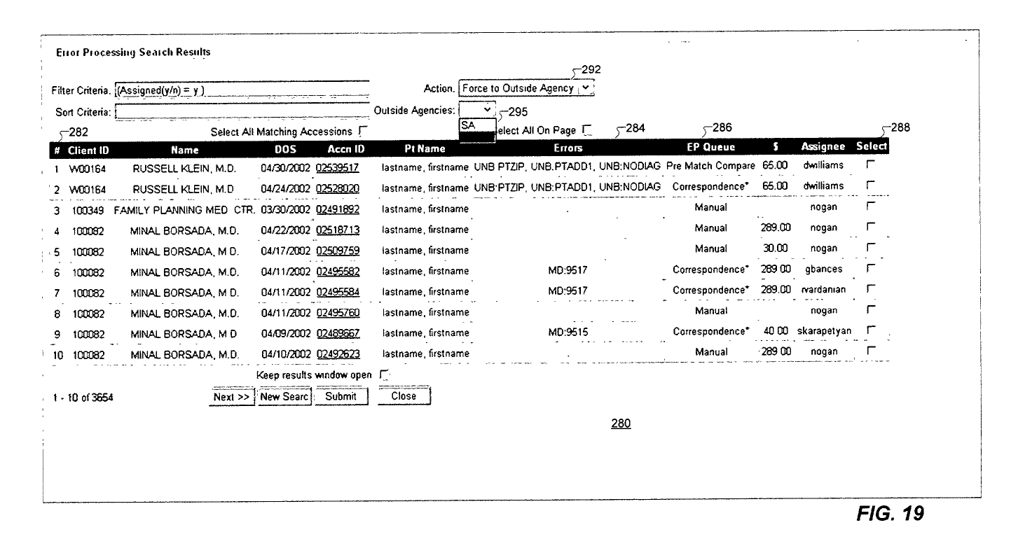

The user may then select an error handling action for the selected accessions (step 246). FIG. 18 is an illustration of the exemplary search results screen 280 of FIG. 17 showing exemplary action selections 293 in accordance with the present invention. In an exemplary embodiment error handling actions may include sending the accession to an outside agency to research the error (“force to outside agency”). When the user selects sending the accession to an outside agency, the user may select an outside agency to receive/research the error (steps 248, 252). FIG. 19 is an illustration of the exemplary search results screen of FIG. 17 showing exemplary outside agency selections 295 in accordance with the present invention. The user may then submit their selected accessions and action (step 254). The CARS 40 may process the selections of screen 280, thus updating the EP queue for the accession in one exemplary embodiment (step 226 of process 220).

While this invention has been described in terms of a best mode for achieving this invention's objectives, it will be appreciated by those skilled in the art that variations may be accomplished in view of these teachings without deviating from the spirit or scope of the present invention. For example, the present invention may be implemented using any combination of computer programming software, firmware or hardware (e.g., a software language, such as C++ or others may be used to implement the invention). As a preparatory step to practicing the invention or constructing an apparatus according to the invention, the computer programming code (whether software or firmware) according to the invention will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the computer programming code is used by either executing the code directly from the storage device, by copying the code from the storage device into another storage device such as a hard disk, RAM, etc. or by transmitting the code on a network for remote execution.

What is claimed is:

1. A method of reducing errors in a plurality of accession records stored in a database of an accession processing system where each accession record includes a plurality of fields, comprising the steps of:
a) enabling a user to select a condition defining an error;
b) retrieving one of the plurality of accession records;
c) determining whether the selected condition defining an error is satisfied by the one of the plurality of accession records; and
d) displaying the one of the plurality of accession records that satisfied the selected condition defining an error.

2. The method of reducing errors in a plurality of accession records of claim 1, wherein each accession record represents a service request.

3. The method of reducing errors in a plurality of accession records of claim 2, wherein each accession record includes a field indicating the payor.

4. The method of reducing errors in a plurality of accession records of claim 3, further comprising the step of enabling a user to select a range of dates and wherein step c) includes determining whether the selected condition defining an error is satisfied by the one of the plurality of accession records and whether the accession record falls within the selected range of dates.

5. The method of reducing errors in a plurality of accession records of claim 4, wherein the range of dates corresponds to the service date for each accession record of the plurality of accession records.

6. The method of reducing errors in a plurality of accession records of claim 5, further comprising the steps of:
e) enabling a user to select a sort field of a plurality of fields; and
f) sorting the ones of the plurality of accession records that satisfied the selected condition defining an error.

7. The method of reducing errors in a plurality of accession records of claim 6, further comprising the steps of:
g) enabling a user to select one of the plurality of accession records that satisfied the selected condition defining an error;
h) enabling a user to select an error handling action to the selected one of the plurality of accession records that satisfied the selected condition defining an error; and
i) performing the selected error handling action to the selected one of the plurality of accession records that satisfied the selected condition defining an error.

8. The method of reducing errors in a plurality of accession records of claim 7, wherein the error handling action may include one of automatic matching, manual match, manual, correspondence, outside referral, and hold.

9. An accession processing system for reducing errors in a plurality of accession records stored in a database of an accession processing system where each accession record includes a plurality of fields, comprising:
a) means for enabling a user to select a condition defining an error;
b) means for retrieving one of the plurality of accession records;
c) means for determining whether the selected condition defining an error is satisfied by the one of the plurality of accession records; and
d) means for displaying the one of the plurality of accession records that satisfied the selected condition defining an error.

10. The system for reducing errors in a plurality of accession records of claim 9, wherein each accession record represents a service request.

11. The system for reducing errors in a plurality of accession records of claim 10, wherein each accession record includes a field indicating the payor.

12. The system for reducing errors in a plurality of accession records of claim 11, further comprising means for enabling a user to select a range of dates and wherein the means for determining includes means for determining whether the selected condition defining an error is satisfied by the one of the plurality of accession records and whether the accession record falls within the selected range of dates.

13. The system for reducing errors in a plurality of accession records of claim 12, wherein the range of dates corresponds to the service date for each accession record of the plurality of accession records.

14. The system for reducing errors in a plurality of accession records of claim 13, further comprising:
e) means for enabling a user to select a sort field of a plurality of fields; and
f) means for sorting the ones of the plurality of accession records that satisfied the selected condition defining an error.

15. The system for reducing errors in a plurality of accession records of claim 14, further comprising:
g) means for enabling a user to select one of the plurality of accession records that satisfied the selected condition defining an error;
h) means for enabling a user to select an error handling action to the selected one of the plurality of accession records that satisfied the selected condition defining an error; and
i) means for performing the selected error handling action to the selected one of the plurality of accession records that satisfied the selected condition defining an error.

16. The system for reducing errors in a plurality of accession records of claim 15, wherein the error handling action may include one of automatic matching, manual match, manual, correspondence, outside referral, and hold.

17. An article of manufacture for use in reducing errors in a plurality of accession records stored in a database of an accession processing system where each accession record includes a plurality of fields, the article of manufacture comprising computer readable storage media including program logic embedded therein that causes control circuitry to perform the steps of:
a) enabling a user to select a condition defining an error;
b) retrieving one of the plurality of accession records;
c) determining whether the selected condition defining an error is satisfied by the one of the plurality of accession records; and
d) displaying the one of the plurality of accession records that satisfied the selected condition defining an error.

18. The article of manufacture for use in reducing errors in a plurality of accession records of claim 17, wherein each accession record represents a service request.

19. The article of manufacture for use in reducing errors in a plurality of accession records of claim 18, wherein each accession record includes a field indicating the payor.

20. The article of manufacture for use in reducing errors in a plurality of accession records of claim 19, further comprising the step of enabling a user to select a range of dates and wherein step c) includes determining whether the selected condition defining an error is satisfied by the one of the plurality of accession records and whether the accession record falls within the selected range of dates.

21. The article of manufacture for use in reducing errors in a plurality of accession records of claim 20, wherein the range of dates corresponds to the service date for each accession record of the plurality of accession records.

22. The article of manufacture for use in reducing errors in a plurality of accession records of claim 21, further performing:
e) enabling a user to select a sort field of a plurality of fields; and
f) sorting the ones of the plurality of accession records that satisfied the selected condition defining an error.

23. The article of manufacture for use in reducing errors in a plurality of accession records of claim 22, further performing:
g) enabling a user to select one of the plurality of accession records that satisfied the selected condition defining an error;
h) enabling a user to select an error handling action to the selected one of the plurality of accession records that satisfied the selected condition defining an error; and
i) performing the selected error handling action to the selected one of the plurality of accession records that satisfied the selected condition defining an error.

24. The article of manufacture for use in reducing errors in a plurality of accession records of claim 23, wherein the error handling action may include one of automatic matching, manual match, manual, correspondence, outside referral, and hold.
